(19) United States
(12) Patent Application Publication
(10) Pub. No.: US 2022/0251817 A1
(43) Pub. Date: Aug. 11, 2022

(54) SYSTEMS AND METHODS FOR MANAGING STORMWATER REGULATIONS

(71) Applicant: Rain Event LLC, Del Mar, CA (US)

(72) Inventors: William Wilson, Oceanside, CA (US); Shaun Knoop, Oceanside, CA (US); Jordan Groth, Brentwood, TN (US); Andrew Penniman, Redmond, OR (US)

(73) Assignee: Rain Event LLC, Del Mar, CA (US)

(21) Appl. No.: 17/535,707

(22) Filed: Nov. 26, 2021

Related U.S. Application Data
(60) Provisional application No. 63/118,560, filed on Nov. 25, 2020.

(51) Int. Cl. E03F 1/00; G01W 1/14; G01W 1/10

(52) U.S. Cl. CPC E03F 1/00; G01W 1/10; G01W 1/14

(57) ABSTRACT

A stormwater compliance plan system is provided for creating, monitoring and complying with stormwater compliance plans (SCPs) using real-time weather and location data along with user-specific task and notification settings networked across a plurality of electronic devices. The real-time data is combined with a site-specific SCP to create a dashboard for continuous management of the SCP, including the generation of events, alerts, tasks and notifications for inspectors, managers and other personnel, along with generation of electronic forms and reports for complying with all necessary regulatory requirements relating to the SCP. Data and images from the site can be uploaded remotely from inspectors at the site using mobile devices, managed remotely by an inspector or manager, and stored remotely and securely in cloud storage for ease of access by any user.

### PRIORITY CLAIM

This application claims the benefit of priority under 35 U.S.C. § 119(e) to U.S. Provisional Application No. 63/118,560, filed Nov. 25, 2020.

### BACKGROUND

### Field of the Invention

Systems and methods described herein relate to stormwater management, and more specifically to a system for utilizing real-time data and predictive analytics to monitor and maintain compliance with stormwater regulations.

### Related Art

Stormwater regulations at the federal, state and local level often require jobsites to develop and submit a detailed stormwater compliance plan (SCP) for preventing stormwater pollution at a jobsite. The goal of this highly-customized SCP is to prevent erosion and sediment runoff at the jobsite by determining all of the potential site-specific risks, taking preventative steps prior to a storm, and monitoring a site before, during and after a storm to take any necessary corrective actions. Compliance with the SCP is a complex, time-intensive process which focuses not only on the creation of the site-specific SCP but which also requires continuous monitoring, inspections and adjustments of the site and the plan due to constantly-changing weather predictions and runoff conditions at the site. SCP compliance thus typically requires the involvement of several people at various locations in constant communication to successfully create and complete numerous forms and tasks related to the plan, both prior to, during and after a storm.

The SCP, in addition to being site-specific, has precise weather-based triggers for when an assessment of the site must be done in relation to the timing and predicted severity of a storm. Managers must monitor not only the predicted arrival of a storm but the specific percentage chance of rain, amount of actual rainfall and overall timing of the storm through official National Oceanographic & Atmospheric Administration (NOAA) weather data that is continuously updated. For example, a small change in the predicted chance of rain from 40% to 50% may trigger a compliance task, as would a change in the measured amount of rainfall during a storm from 0.5 inches per hour to 0.75 inches per hour.

Most significantly, failure to comply with the SCP or the failure of the SCP to prevent stormwater pollution results in significant monetary penalties, delays in construction, and additional time and money to take corrective actions. For all of these reasons, many jobsites hire outside companies simply to create and manage the SCP. However, even these companies require significant personnel, coordination and communication to effectively manage the SCP amidst constantly changing conditions. Therefore, there is a continuing need to simplify and streamline the process of creating, monitoring and complying with an SCP.

### SUMMARY

Embodiments described herein provide systems and methods for creating, monitoring and complying with a stormwater compliance plan (SCP) using real-time weather and location data along with user-specific task and notification settings networked across a plurality of electronic devices. The real-time data is combined with a site-specific SCP to create a dashboard for continuous management of the SCP, where the system provides data analytics for the generation of events, tasks and notifications for inspectors, managers and other personnel, and automatic generation and completion of electronic forms and reports for complying with all necessary regulatory requirements relating to the SCP. Data and images from the site can be uploaded remotely from inspectors at the site using mobile devices, managed remotely by an inspector or manager, and stored remotely and securely in cloud storage for ease of access by any user. Additionally, geolocation features can be utilized to manage the scheduling and routing of inspectors to the sites based on the real-time and predicted conditions.

In one embodiment, a method of managing a stormwater compliance plan (SCP) comprises the steps of: receiving an SCP for a site, the SCP including requirements for complying with the SCP; assigning responsibilities for complying with the SCP to a plurality of users; receiving real-time weather information in relation to the site; comparing the real-time weather information with the SCP requirements to determine if a threshold for a rain event is met; generating one or more alerts, notifications and tasks in relation to the created rain event; transmitting the one or more alerts, notifications and tasks to the plurality of users based on their assigned responsibilities; and receiving compliance activity information from the plurality of users relating to actions taken by the plurality of users to comply with the SCP.

In another embodiment, a system for managing a stormwater compliance plan (SCP) comprises: a management device which inputs stormwater compliance information for a jobsite; a compliance server configured to: generate the SCP based on the stormwater compliance information, a location of the jobsite and local weather information; assign responsibilities for complying with aspects of the SCP to a plurality of users; receive real-time weather information in relation to the site from a weather information server; compare the real-time weather information with the SCP requirements to determine if a threshold is met fora rain event; generate at least one task for completion by one or more of the plurality of users based on the assigned responsibilities in order to maintain compliance with the SCP; transmit the at least one task to one or more of the plurality of users at a user device; and receive compliance activity information from the user device relating to actions taken by the plurality of users to comply with the SCP.

In a further embodiment, a method of stormwater compliance management, comprises: receiving stormwater site information for a jobsite; receiving stormwater regulation information pertaining to the jobsite; obtaining weather location information relative to a location of the jobsite; creating a stormwater compliance plan using the stormwater site information, stormwater regulation information and weather location information, the stormwater compliance plan including requirements for complying with the stormwater regulation information for the jobsite; utilizing the stormwater compliance plan in conjunction with real-time weather information to generate at least one action item required for complying with the stormwater regulation information; and transmitting the at least one action item to a user with a recommended action for complying with the stormwater compliance plan.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a flow diagram for creating and managing a stormwater compliance plan (SCP), as is known in the art;

FIG. 2 is a block diagram of a system for managing an SCP, according to one embodiment of the invention;

FIG. 3A is an image of a graphical user interface (GUI) of an SCP jobsite overview, according to one embodiment of the invention;

FIG. 3B is an image of a management detail view of each jobsite, according to one embodiment of the invention;

FIG. 4 is an image of a graphical user interface (GUI) of an SCP management dashboard, according to one embodiment of the invention;

FIG. 5 is an image of a jobsite compliance overview, according to one embodiment of the invention;

FIG. 6 is an image of a jobsite form notification menu, according to one embodiment of the invention;

FIG. 7 is an image of a jobsite entry interface, according to one embodiment of the invention;

FIG. 8 is an image of a jobsite event history interface, according to one embodiment of the invention;

FIG. 9 is an image of a jobsite reports interface, according to one of embodiment of the invention;

FIG. 10 is an image of an incident log interface, according to one embodiment of the invention;

FIGS. 11A and 11B are images of a compliance reporting interface, according to one embodiment of the invention;

FIGS. 12A and 12B are images of a jobsite activity selection menu for selecting one or more compliance regulations, according to one embodiment of the invention;

FIGS. 13A and 13B are images of a predicted rain event actions menu, according to one embodiment of the invention;

FIG. 14 is an image of a compliance information input interface, according to one embodiment of the invention;

FIG. 15 is a flow diagram illustrating an example method of managing the SCP, according to an embodiment of the invention; and

FIG. 16 is a block diagram illustrating an example wired or wireless processor enabled device that may be used in connection with various embodiments described herein, according to one embodiment of the invention.

### DETAILED DESCRIPTION

Certain embodiments disclosed herein provide for creating, monitoring and complying with stormwater compliance plans (SCPs) using real-time weather and location data along with user-specific task and notification settings networked across a plurality of electronic devices. The real-time data is combined with a site-specific SCP to create a dashboard for continuous management of the SCP, including the generation of events, tasks and notifications for inspectors, managers and other personnel, along with generation of electronic forms and reports for complying with all necessary regulatory requirements relating to the SCP. Data and images from the site can be uploaded remotely from inspectors at the site using mobile devices, managed remotely by an inspector or manager, and stored remotely and securely in cloud storage for ease of access by any user. The system analyzes all of the information from the SCP with the real-time weather data to not simply notify a user of an issue but also determine the action that needs to be taken in order to ensure that the users can maintain compliance with the SCP.

The SCP management system allows for continuous, real-time management of an SCP by multiple parties at various locations using live weather and location data to generate notifications and tasks for inspectors and managers in order to simplify the overall process of SCP compliance. Management of multiple SCPs for multiple sites is provided and can be factored into the notifications and tasks that are sent to specific inspectors based on their location and availability, with notifications for overall site management going to managers using a management dashboard or job site dashboard.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

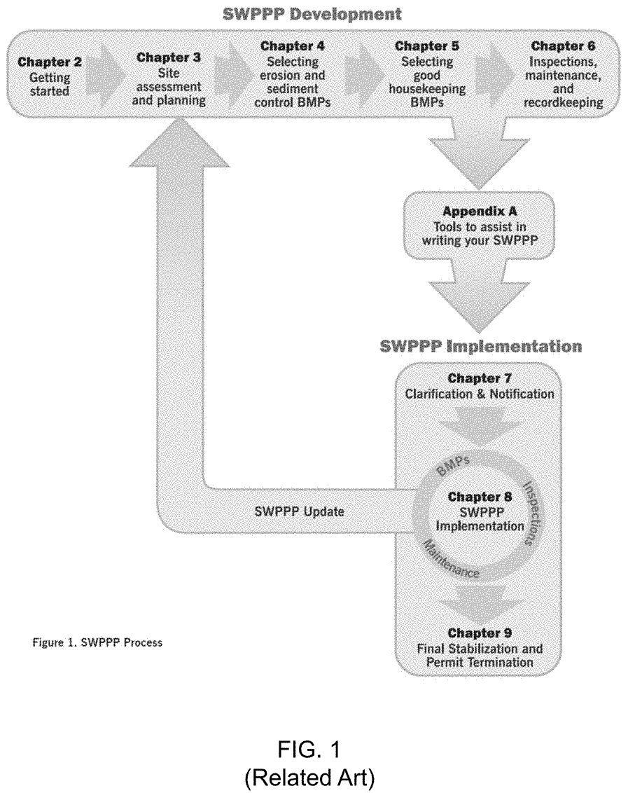

FIG. 1 is flow diagram of an overall process for generating and managing a stormwater compliance plan based on parameters and regulatory thresholds developed into a Stormwater Pollution Prevention Plan (SWPPP), as provided by the Environmental Protection Agency (EPA) through the National Pollutant Discharge Elimination System (NPDES) (“Developing Your Stormwater Pollution Prevention Plan,” available at https://www.epa.gov/npdes/developing-stormwater-pollution-prevention-plan-swppp, Accessed Jun. 22, 2020). The NPDES governs all industries that discharge stormwater and sets the regulation parameters that are encompassed within an SWPPP that is developed by an engineer for each site. The systems and methods described herein pertain in a broad sense to the SWPPP Implementation phase, particularly the steps of creating notifications, assigning inspections and performing maintenance at each site. It should be noted that the systems and methods described herein may be implemented for creating and complying with any stormwater compliance plan, whether it is an SWPPP created via the NPDES rules or any other federal, state or local compliance program.

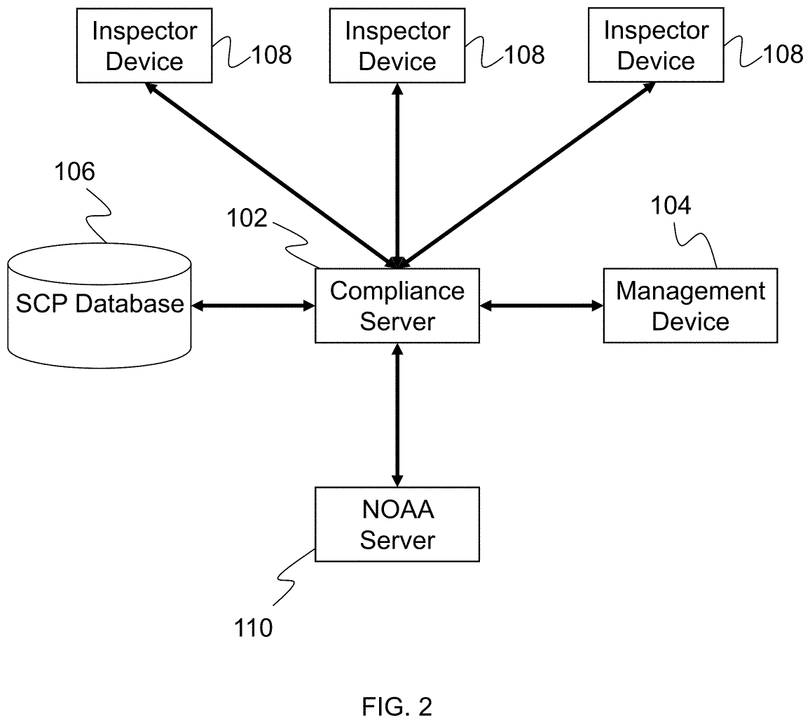

FIG. 2 is a diagram illustrating one embodiment of a system for SCP management, which includes a Compliance Server 102 in communication with a Management Device 104, an SCP Database 106, a plurality of Inspector Devices 108 and a National Oceanographic & Atmospheric Administration (NOAA) Server 110. The Compliance Server 102 may be configured to receive, process and transmit data from all other components of the system and is generally responsible for the overall implementation of the SCP management system. This includes communicating with the Management Device 104 controlled by a manager or other user responsible for inputting and monitoring the SCP, by inputting site information, location information, erosion issues, responsible users, tasks, rules and other notifications, settings and requirements for compliance with the SCP. The Compliance Server 102 may also communicate with the NOAA Server 110 and other nearby weather stations in real-time to continuously receive weather data related to predicted storms for each site, including predicted percent chance of rain, hourly recorded rain totals and predicted amounts of rain. This weather information is continuously updated and often changes before, during and after a storm, requiring the Compliance Server 102 to continuously request updated data so that the any tasks, which the Compliance Server 102 utilizes along with each SCP to determine if tasks, activities and alerts need to be generated for one or more of the system users in order to maintain compliance.

All of the data received at the Compliance Server 102 from the Management Device 104 and NOAA Server 110 may be stored in the SCP Database 106. The SCP Database 106 may also store sets of rules, forms, reports and other information necessary to comply with the SCP, which can be accessed by the Compliance Server 102 and distributed to the Management Device 104 or Inspector Devices 108. The SCP Database 106 may also store user information on which inspectors and managers are responsible for certain sites and SCPs, including specific tasks and actions, which notifications should be sent to which users, and the location information of inspectors and inspector devices 108 in order to perform location-based decisions on which inspectors should handle particular tasks. This location-based information is particularly useful since storm prediction information from the NOAA Server 110 may change rapidly before, during or after a storm, requiring immediate reactions to prepare a site for a storm, mitigate site pollution during a storm, and repair or clean up pollution after a storm.

The Compliance Server 102 is responsible for implementing specific algorithms and rule sets for each SCP in order to determine which alerts, tasks, notifications, reports, forms, etc. should be generated and sent to each specific user. The Compliance Server 102 may also provide analytics for each of these determinations in order to aid the user in understanding the alerts and notifications more clearly and in completing and submitting any form or report information.

One specific way in which the Compliance Server 102 aids in this process is by determining the most accurate weather information related to a site. The system is configured to compare the location of a site with the location of the NOAA weather stations reporting relevant data in order to determine which weather station will have the most relevant information to a particular site. This determination may be more advanced than simply identifying the closest weather station to a particular site, as geographic, climate and weather pattern information may dictate that a weather station further away from a site but in the path of an incoming storm will better predict the storm in relation to the site. Additionally, if the weather data from a nearby NOAA station is inconsistent, the system will utilize data from another nearby station with more consistent weather data.

In one embodiment, if the weather data meets a certain threshold of three factors—predicted percentage chance of rain, predicted hourly rainfall and total rainfall, a rain event, sometimes referred to as a Qualifying Rain Event (QRE) or Qualifying Storm Event (QSE), is generated. This causes the Compliance Server 102 to generate a set of alerts, tasks, notifications, etc. that are distributed to the appropriate users of the system for taking the appropriate action in accordance with the SCP. Alerts and notifications may be sent to one or more users responsible for a jobsite to notify them of an upcoming rain event. Tasks are more complex notifications which take into account the details of the rain event—the percent change of rain, the expected rainfall total, the timeframe of arrival and duration, etc.—and then generate specific actions which one or more users need to take in order to maintain compliance with the SCP. The tasks utilize the detailed real-time weather information, the parameters of the SCP regulations and the assigned user responsibilities to generate customized and individualized tasks which ensure that all users can easily and effectively take the actions needed to complete the generated tasks and maintain compliance with the SCP. For example, the tasks may tell the users to complete certain types of pre-storm, post-storm or live-storm inspections based on the weather conditions and the SCP.

It will be appreciated that the SCP management system described herein may include one or more separate servers, databases and devices for processing, storing, displaying and receiving the relevant data required to implement the SCP management system. Additionally, while the system may primarily be designed for internal communications between users, in one embodiment, the system may generate external reports, hyperlinks, information and other content that may need to be shared or submitted to a third-party—such as a client in charge of the overall jobsite or a regulatory body which requires submission of the compliance and other activity at the jobsite. In this aspect, the system may automate these third-party communications to further ensure compliance not simply with the regulations at the jobsite, but with the reporting requirements of a relevant government body or contractual obligation with a client, sub-contractor, etc.

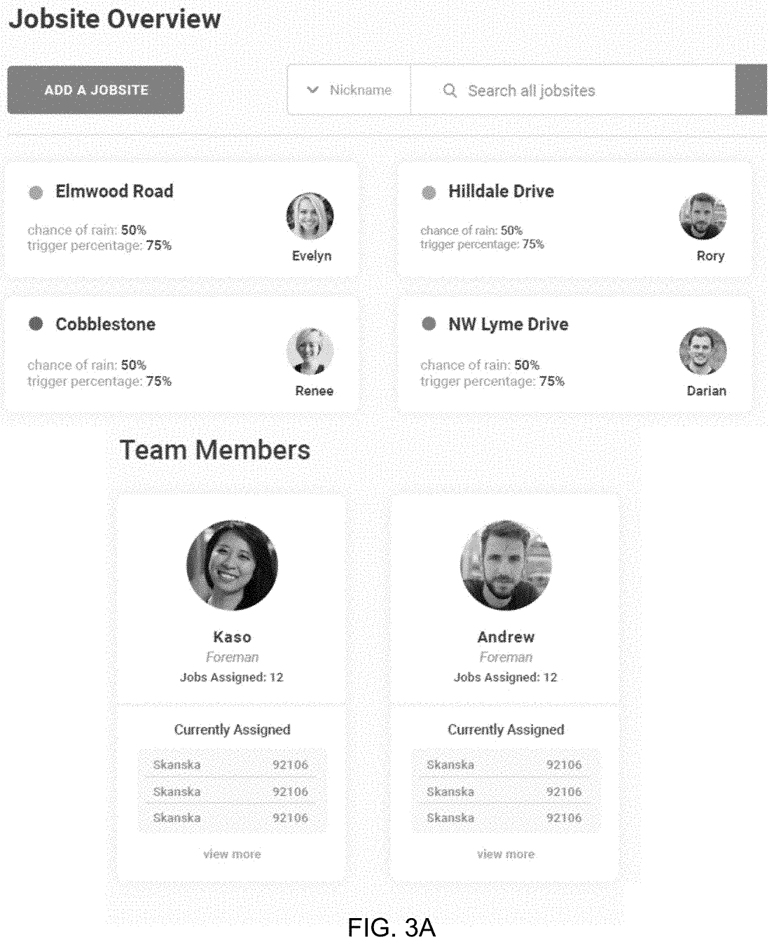

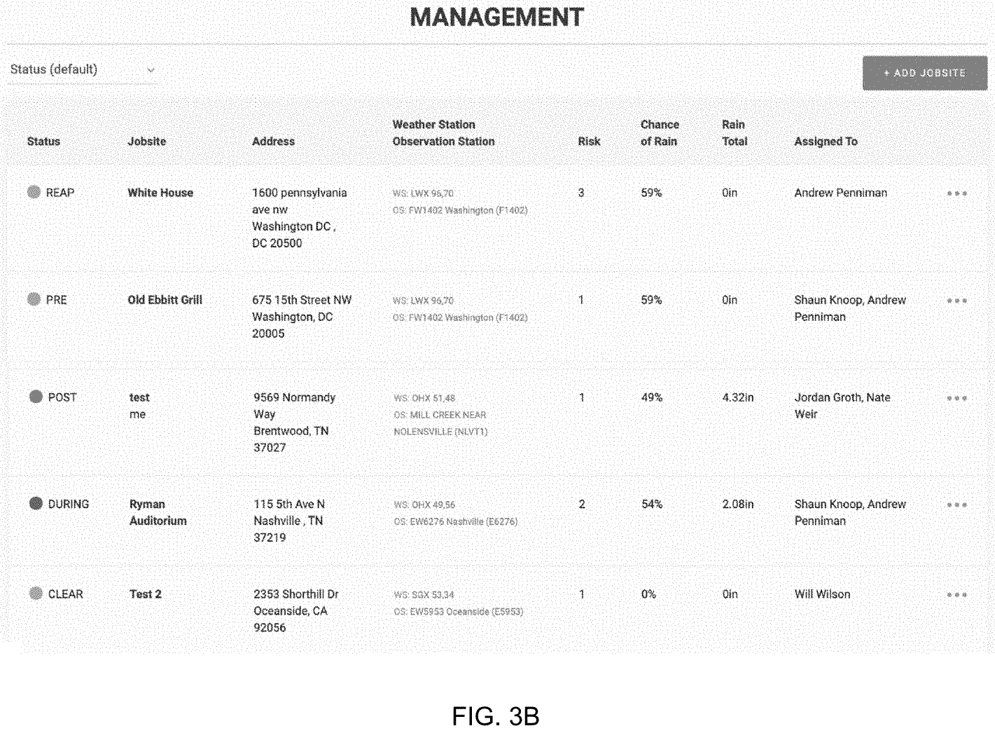

FIG. 3A is an image of one embodiment of a graphical user interface (GUI) of an SCP job site overview dashboard displaying a summary and status of multiple jobsites, relevant users to each jobsite and other team members and summaries of their relevant jobsites and assignments. The overview of a particular site SCP may include alerts, notifications, tasks, reports, status identifiers, forecast information, etc. The job site dashboard may provide jobsite-specific information on the weather forecast, past weather data, previously-completed forms and reports, currently-needed forms and reports, event histories of previous QREs at the site and current tasks and responsible parties.

In the embodiment shown in FIG. 3A, each jobsite is listed with an icon for its location, such as “Elmwood Road,” and a circular status identifier indicating if there is a current rain event, task or action required to be completed at that location. For example, a green identifier indicates that there are no issues at the jobsite, while a red identifier indicates a current rain event, while a yellow might indicate that a rain event no longer exists but an action is still required at the jobsite from a previous event. The jobsite icon may further include a current chance of rain percentage, a “trigger percentage” chance of rain indicating the threshold percent of rain which would automatically create a rain event and trigger the notifications, alerts and tasks. Another option is a notification percentage that can be set prior to the trigger percentage, such that a user can be notified in advance of the chance of rain reaching the trigger percentage. The jobsite icon also displays the user who is managing the jobsite.

FIG. 3B is an image of a management detail view of each jobsite with a status, weather station, risk level, rain chance, rain total and user assignment for the jobsite.

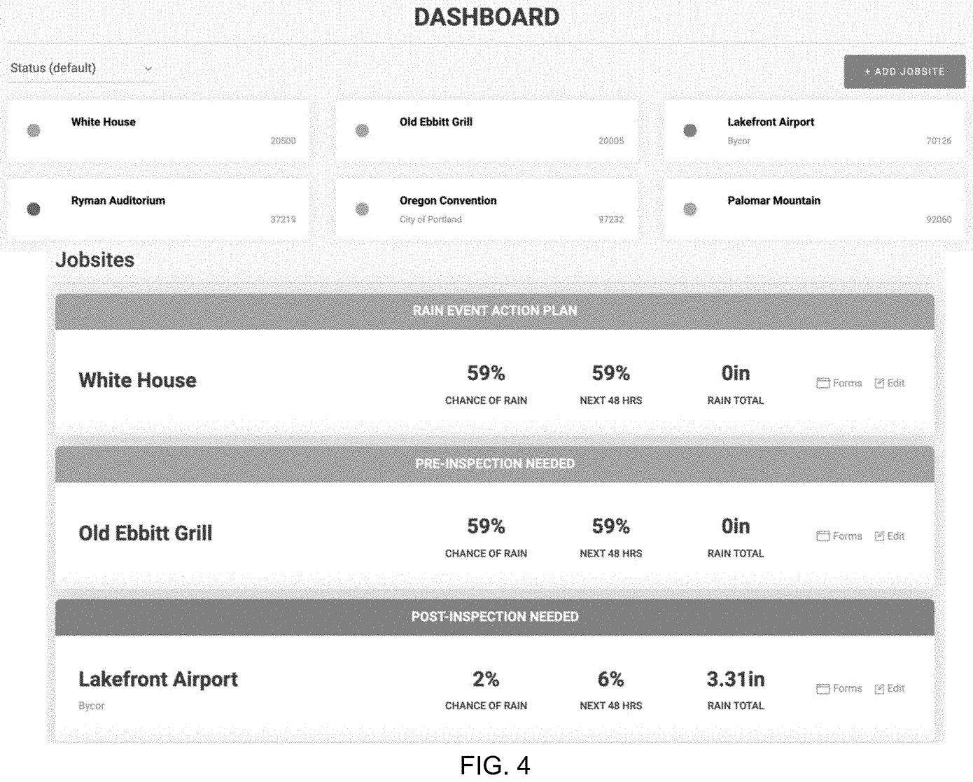

FIG. 4 is an image of one embodiment of an SCP management dashboard which displays jobsite icons along with a jobsite detail list. In this interface, the jobsite detail list provides the chance of rain, the chance within the next 48 hours, and the total rain total at this site, which are all components of a rain event that are utilized to determine if an alert, notification or task are generated. Additionally, a link to a forms section with options to prepare forms related to reporting compliance activities and information regarding rain events may be provided, along with edit options to edit information about the job site, compliance regulations, thresholds, etc. As with the identifiers used in FIG. 3, the title bar for each jobsite may be color coded based on a relevant action item or rain event status, and further be labeled with the action item needed.

The management dashboard may show a list of all SCPs being managed by a particular manager, company, contractor, etc., and provide basic notification information for that SCP to indicate if there is a new alert, task, notification, etc. that requires action by the manager or an inspector. The manager may be able to take actions via the dashboard without needing to access separate SCP GUIs, such as viewing an alert or notification or assigning an inspector to complete a task, form or report.

The manager can also utilize the manager dashboard to communicate with other users, such as inspectors, other managers, regulators, etc., and the manager dashboard may also provide analytics for each site and SCP indicating a degree of importance of certain alerts, tasks and notifications, perhaps due to the time prior to a storm event's predicted arrival or severity for a particular site. The analytics will therefore aid the manager in implementing the necessary steps to comply with the SCPs in order of priority and severity. Additional analytics may provide the manager with data on site-specific conditions being reported by inspectors at the site, via inspector reports or uploaded images or communications.

In one embodiment, the SCP management system provides an inspector location management system which provides real-time tracking of an inspector's location and assigned job sites to optimize the scheduling and routing of the inspector from one job site to another based on a current or upcoming job site inspection status. The inspector may receive a daily inspection schedule with an ordered list and route guidance to travel between each site. Additionally, the inspector location management system may also incorporate the weather data and forecast information in order to determine if an inspector should be routed to a particular job site over another due to an imminent threat of a rain event, an existing rain event or a recently completed rain event at a particular job site that would require a more immediate pre-storm, live storm or post-storm inspection. If an urgent situation arises where an assigned inspector is unable to reach a job site to complete an inspection with a needed time frame relative to the rain event, the system could assign another inspector in the vicinity to perform the inspection. The entire system may also be configured to assign inspectors based on geolocation data of the inspector and the relevant job sites requiring inspection.

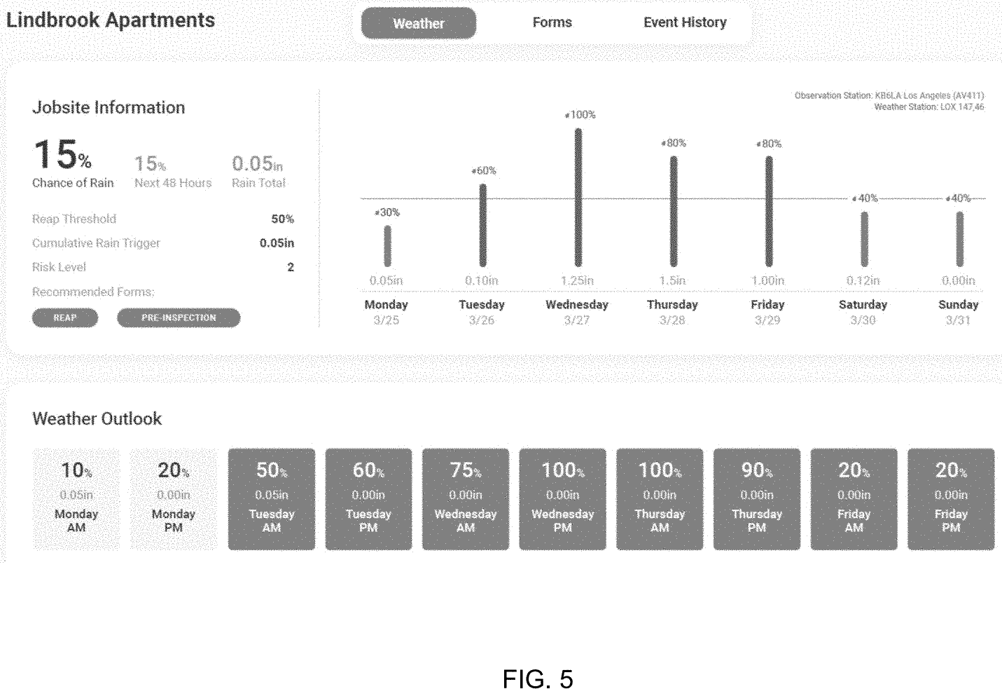

FIG. 5 is an image of one embodiment of a jobsite compliance overview page which shows more detailed information for a particular jobsite. The jobsite overview page provides an information summary of the current percent chance of rain at the site, the percent chance over the next 48 hours, and the current rain total, along with one or more charts and informational displays. The threshold measurements for when a rain event triggers an update, such as a Rain Event Action Plan (REAP) or Pre-Storm, may also be listed here to illustrate how the user can quickly assess all of the real-time information and make instant decisions regarding an action. The compliance overview also include a detailed weather forecast over a long period of time, such as seven days, to help the managers better plan for future compliance actions. In this embodiment, the weather station used to generate the forecast is listed as well, as the system may utilize one or more weather sources selected based on the location of the jobsite, including a weather station and observation station.

The jobsite compliance overview page can be used by an inspector at the jobsite via a mobile device or a manager at a remote location on another computing device to manage and view alerts, tasks, forms and reports at a site or elsewhere in the field. The SCP inspector dashboard may provide the inspector with an overview of a particular SCP or site, or an overview of all of the inspector's SCP's and sites, along with alerts, tasks, notifications, etc. for each site and SCP. The compliance overview will allow the inspector to view all of the relevant information on a site and it's corresponding SCP updated in real-time as it relates to an upcoming, current or past rain event, and further allow the inspector to input site-specific and SCP-specific information into the system for reporting to managers and other users to create additional tasks and activities, complete forms, submit evidence of compliance actions or request additional information or resources. The inspector is able to upload data in the form of reports, forms, images and traditional communication-protocols in order to effectively transmit the relevant information to the relevant party for ensuring compliance with the SCP.

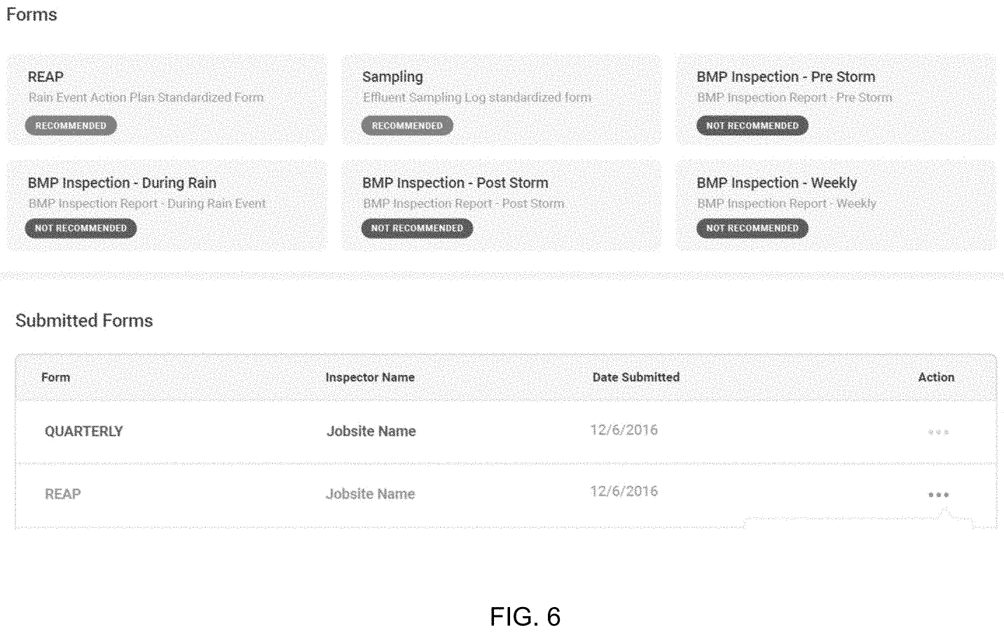

FIG. 6 is an image of one embodiment of a forms dashboard which allows a manager, inspector or other user to electronically create, complete and submit any form or report required for SCP compliance. The form and report dashboard may also display notifications to the relevant users to alert the users as to which forms or reports need to be completed, whether they have been completed properly, and whether they have been submitted and/or approved by a manager or regulatory authority. As described above, the system is able to combine the regulatory and site-specific information in the SCP with the real-time weather information to generate recommendations and notifications for the forms and actions that need to be taken in order to comply with the SCP. Those forms and actions are then displayed on the dashboard and can be pushed out to the relevant users who have been assigned the specific tasks relevant to compliance. The form and report dashboard may also provide site-specific and SCP-specific information to aid the user in completing the report based on the past, present or predicted weather conditions or predicted stormwater pollution conditions at the site.

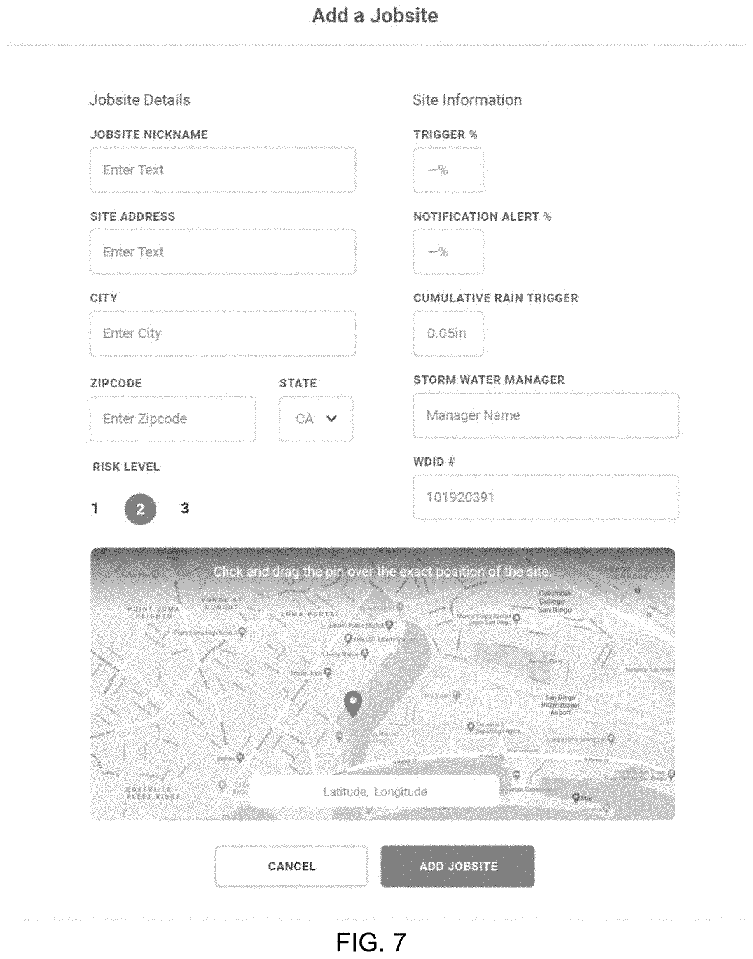

FIG. 7 is an image of a jobsite entry interface where a user can create a jobsite and enter the information needed to create an SCP. In addition to the location information, the user can input the trigger percentage chance of rain that will trigger a rain event and related compliance activity, a notification alert percentage that will notify the users in advance of the trigger percentage, a cumulative rain trigger amount that will trigger a rain event and compliance activity, and the names of a manager for the jobsite and other identifying information for the site. Additionally, the jobsite entry interface may have an interactive map which allows the user to manually select the location of the jobsite if there is no official postal address to be entered, as is often the case at a construction site. In this embodiment, a “risk level” can also be input that may determine the level of compliance, reports and other actions that need to be taken at a jobsite based on the risk of stormwater runoff at the site and to the surrounding area. For example, the Rain Event Action Plan (REAP) may be utilized for a jobsite with a risk level of 2 or 3, and by inputting the risk level into the jobsite information, the system will then automatically generate the necessary forms, actions, tasks, alerts and notifications relevant to that risk level.

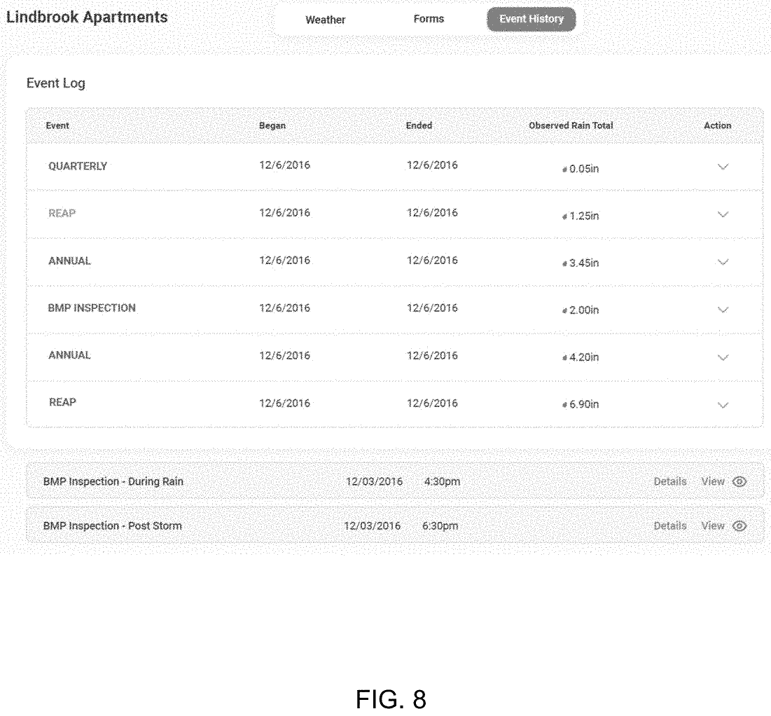

FIG. 8 is an image of a jobsite event history interface which displays an event log of all activity at a jobsite, including all forms, reports, inspections and other events, along with details on the date of the start and end of the rain events, observed rain totals, and an Action menu that allows a user to select an action to take for the report.

It should also be noted that the jobsite event history may also be utilized as an automated billing feature to generate an invoice for a client based on the activity completed at the jobsite. The detailed time information, forms submitted and actions taken can also be combined with task-based billing to automatically generate an invoice for the work as it is being completed or in regular intervals, even including a threshold level such that an invoice is only generated once a certain number of activities or certain amount of cost has been incurred for the related activities.

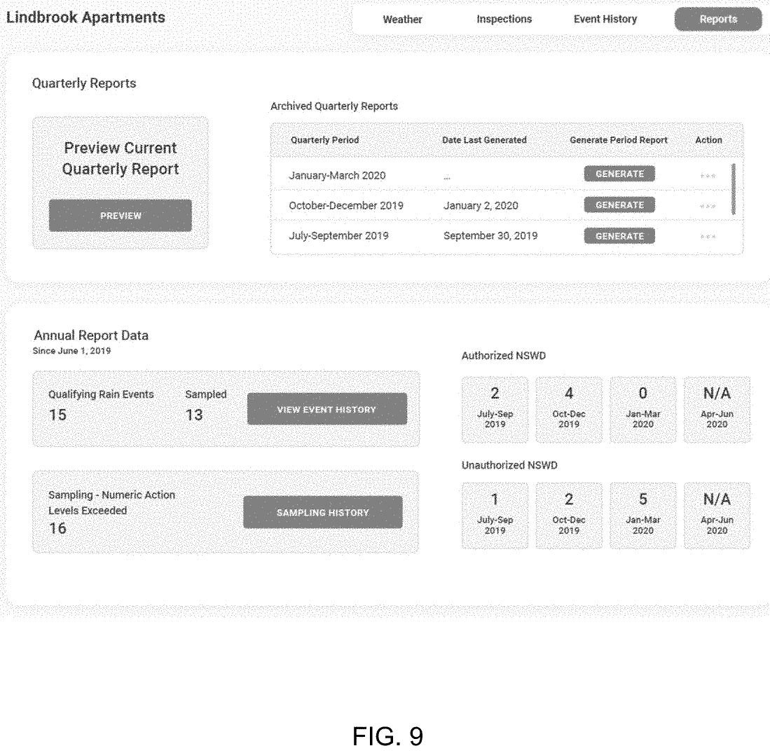

As shown in FIG. 9, a Reports Interface may display summary reports—such as quarterly or annual reports—that are required to be completed annually and include historical data for a site over the previous year, all of which can be collected, managed and summarized using the system described herein. The reports can be automatically generated by the system on an ongoing or regular basis to match the requirements for when the summary reports need to be submitted. The annual reports may include, amongst other things: sampling data, the number of QREs, major recurring deficiencies and non-stormwater discharge events, precipitation, corrective action summaries, identification and status of compliance activities or corrective actions, summaries of all violations of a general permit, and training records—all of which can be automatically compiled for each site on an ongoing or periodic basis without requiring specific input by the inspector or manager. The data may be captured from the raw data input by the NOAA weather information, by the inspector-input data, or by collecting data from previously-submitted forms.

The Reports Interface may also include a summary of the reports that have been made and a summary of the report information—such as the number of rain events, the number of samples taken, the number of incidents, actions, exceeded threshold levels, etc. over specified periods of time that align with the regulatory requirements for a particular jobsite. Additional summaries of events and sampling at the jobsite may be generated to further inform the reports and provide additional detail.

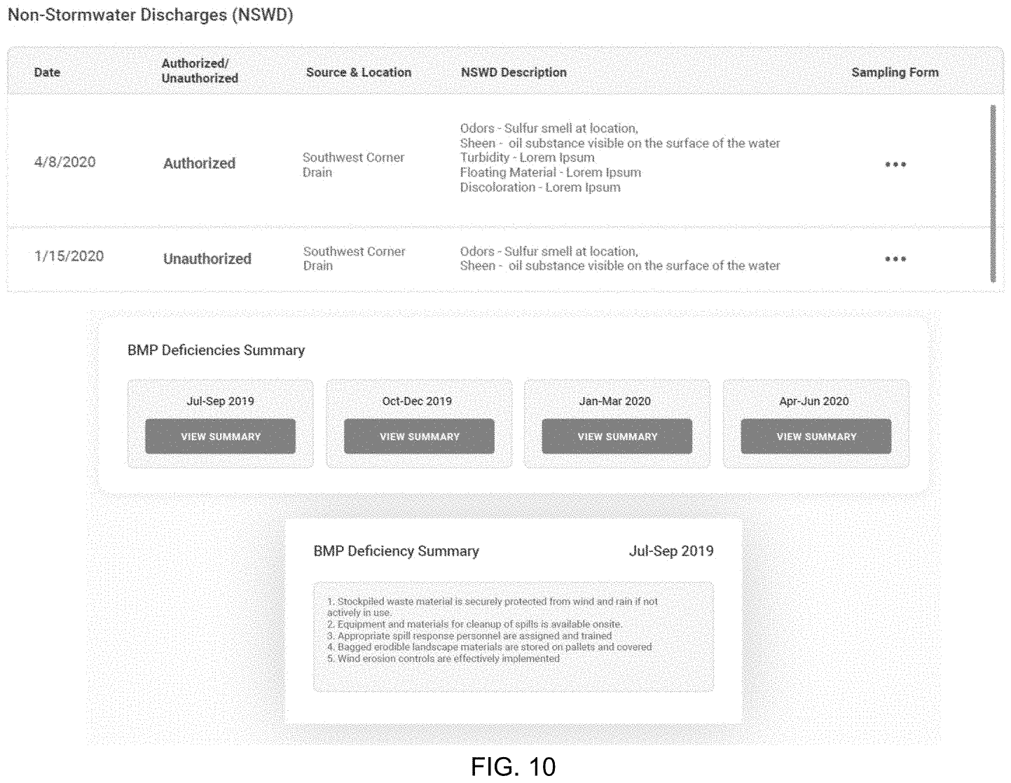

FIG. 10 is an image of an incident log interface of compliance issues identified at a particular jobsite, including Non-Stormwater Discharges (NSWD), a BMP Deficiencies Summary with quarterly breakdowns and detailed information for each summary. The detailed information in the NSWD allows the user to see the specific source, location and description of each compliance issue.

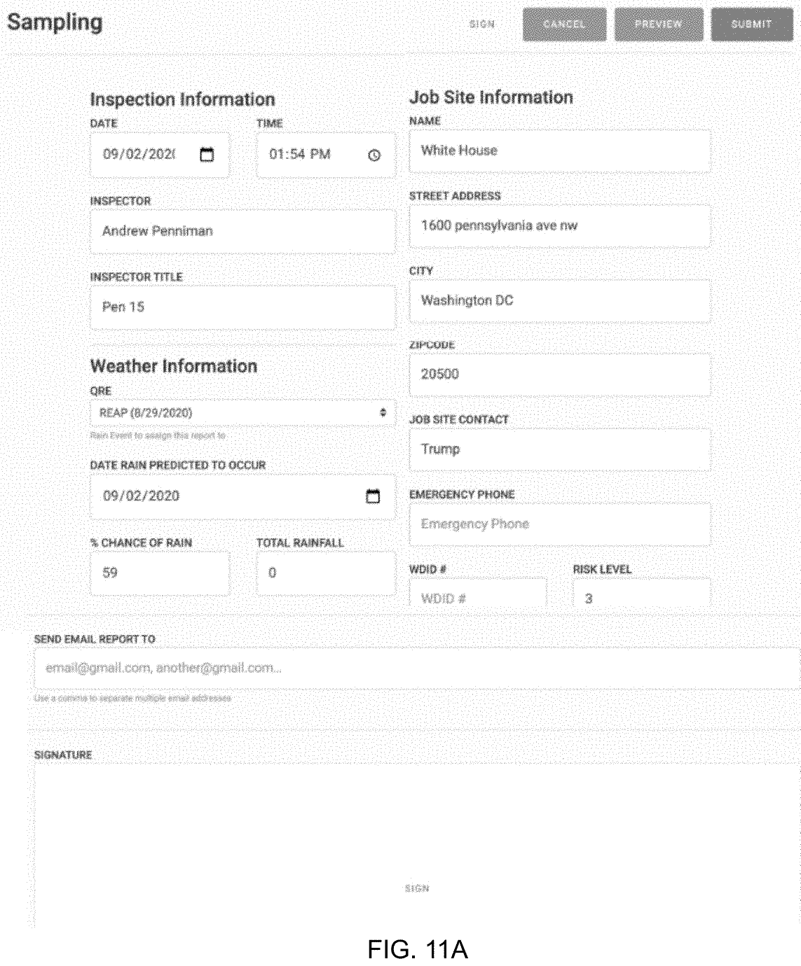

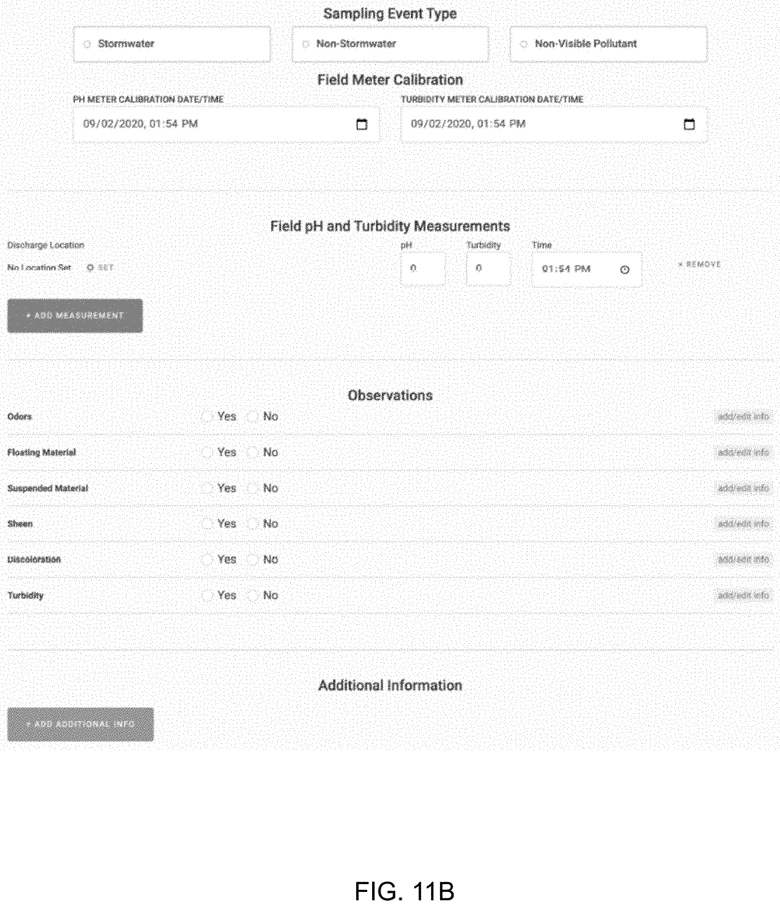

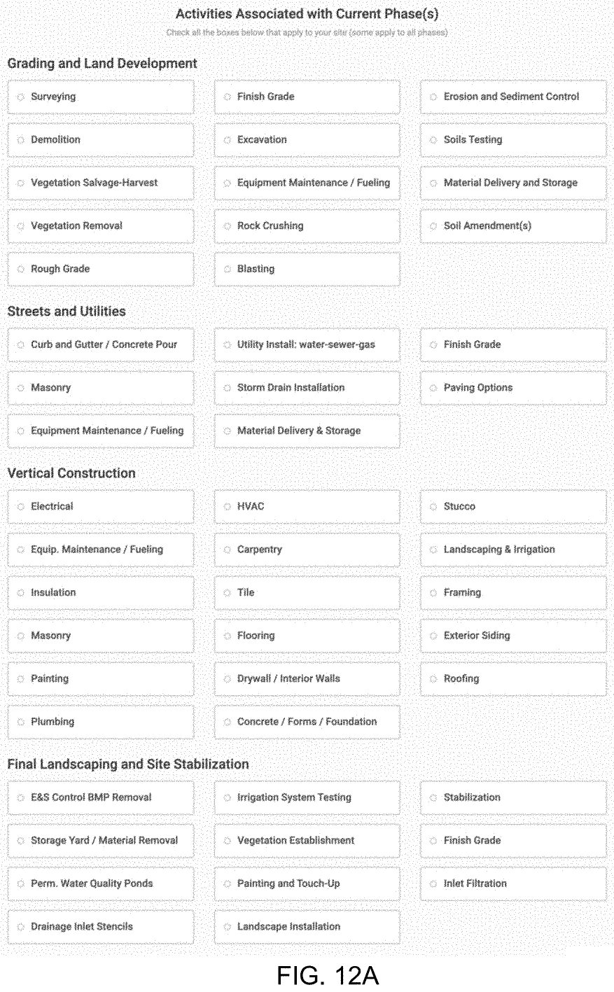

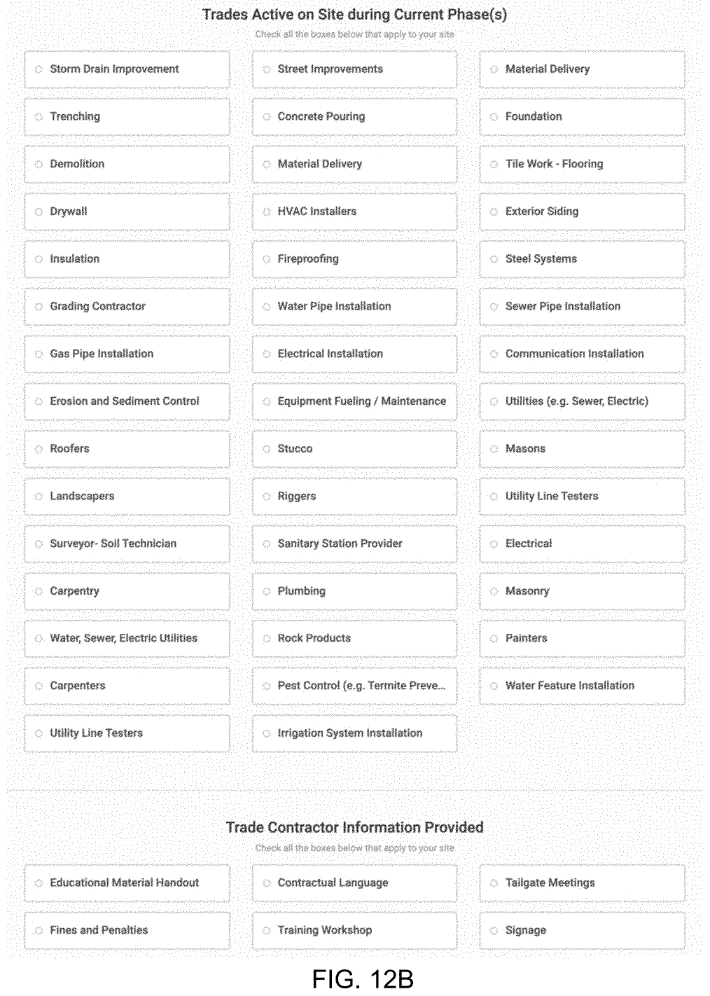

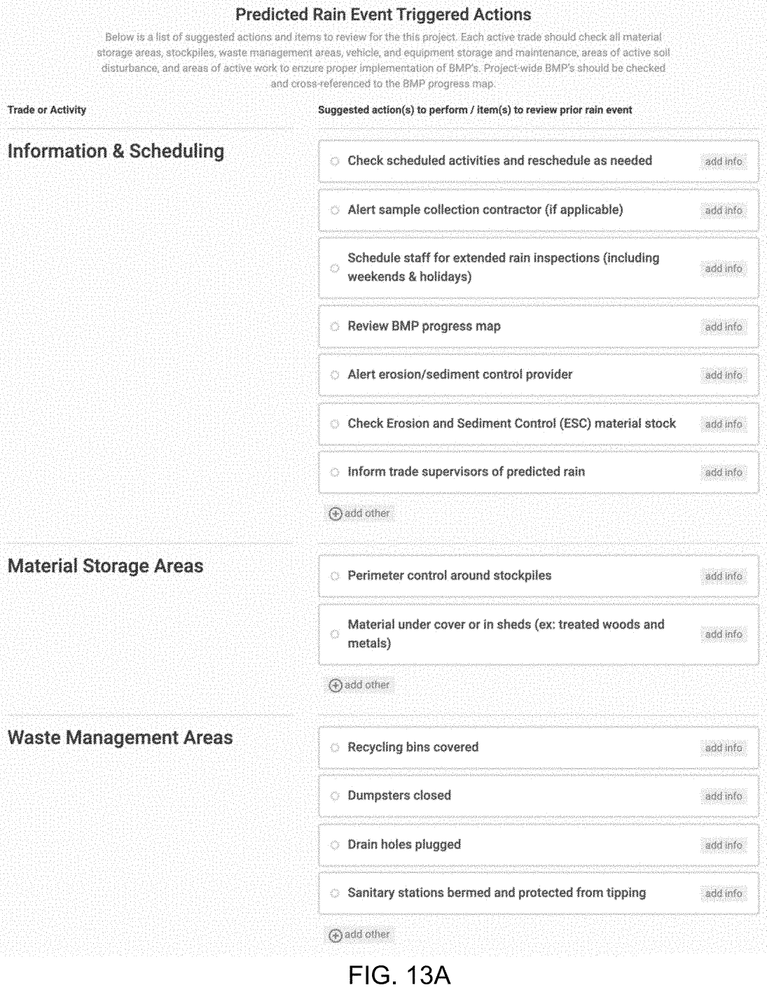

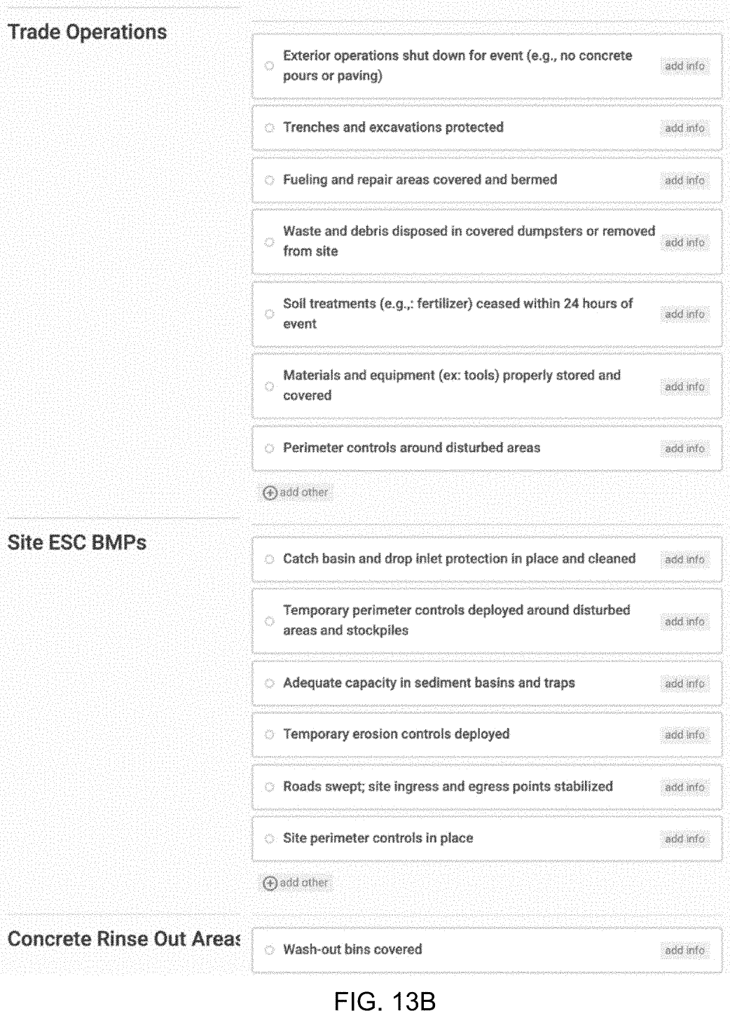

FIGS. 11A, 11B, 12A, 12B, 13A and 13B are images of a compliance reporting interface for creating a Rain Event Action Plan (REAP) Form. In addition to the basic jobsite information shown in FIG. 11A, the interface also allows the user to enter information on a Current Phase of Construction and a variety of activities for that phase of construction (see FIGS. 12A and 12B) which will then utilize the location, appropriate regulatory requirements and other information to generate the SCP and create the notifications, alerts and tasks for any rain event. For example, if grading and land development is being done at a jobsite, specific runoff requirements must be implemented and will therefore cause the system to generate action items based on those requirements when a rain event is predicted. In FIGS. 13A and 13B, a list of suggested action can be selected and scheduled based on all of the activities selected above, including actions such as the generation of a form or report on a particular rain event in relation to the selected activities.

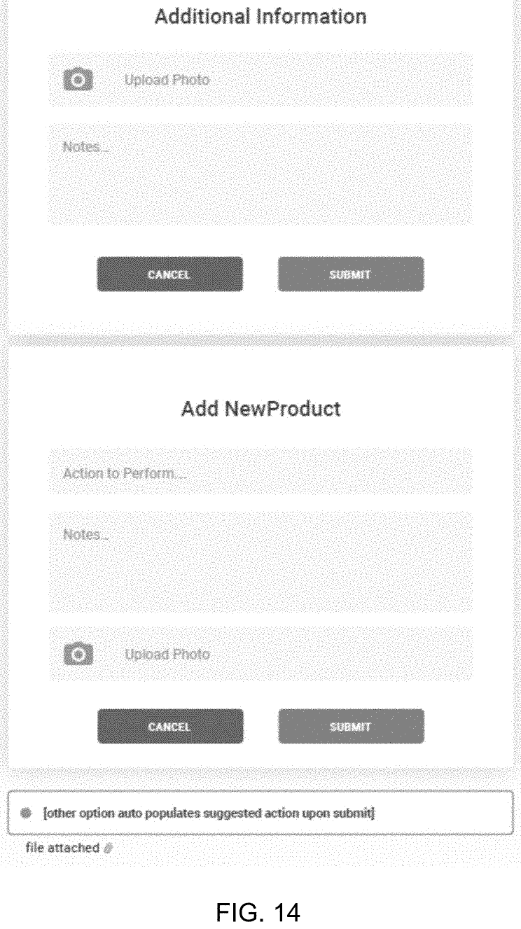

FIG. 14 is an image of a compliance information input interface where an inspector at the jobsite can gather and submit evidence related to the SCP and compliance with a rain event task. For example, the inspector can submit photos, files and text, along with creating an action that needs to be taken, in relation to an observed issue prior to a rain event or an issue identified during or following a rain event.

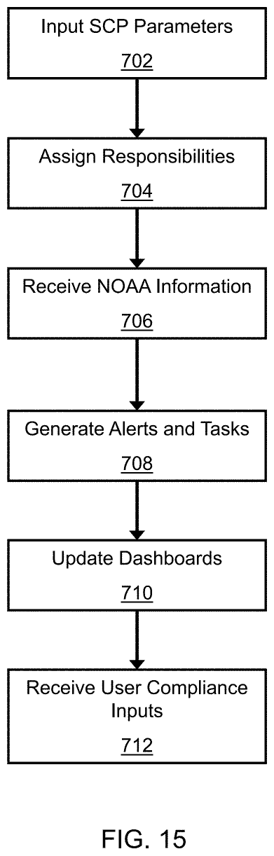

FIG. 15 is a flow diagram illustrating an example method of creating and managing a stormwater compliance plan (SCP), according to one embodiment of the invention. In step 702, regulatory parameters and other information for an SCP are input into the system by a user, including the location, regulations and regulatory thresholds, rules, tasks, reports, forms and information relating to compliance with the SCP. In step 704, the responsibilities for compliance with all of the requirements of the SCP are assigned to the various users of the system, such as inspectors and managers. In step 706, the system receives NOAA weather information such as predicted percent changes of rain, predicted or current rainfall, etc., and in step 708, the NOAA weather information is compared with the SCP information to generate customized alerts, notifications, tasks, reports, etc. via the compliance server. In step 710, the various dashboards for the inspectors, managers and other users are updated with the generated alerts, notifications, tasks, reports, etc. so that the users are aware of the actions that need to be taken to ensure compliance with the SCP. In step 712, the system receives information from the various users as to the actions taken in order to respond to any alerts or notifications and complete any tasks, reports, etc. to maintain compliance with the SCP.

In one embodiment, the system allows the users to customize the alerts, notifications, tasks, etc. so that each is generated only when a threshold weather-related value is reached. For example, if the SCP calls for a pre-storm inspection when the predicted chance of rain is greater than or equal to 50%, the user can create an alert when the NOAA predicted chance of rain is at a minimum of 40% in order to give the users an advance warning that a site visit and pre-storm inspection may be needed. The system may also look at the historical trend of the predicted percent chance of rain to determine if the chance of rain is increasing or decreasing over time, which would provide the user with more accurate information as to whether a storm is more or less likely to require an inspection.

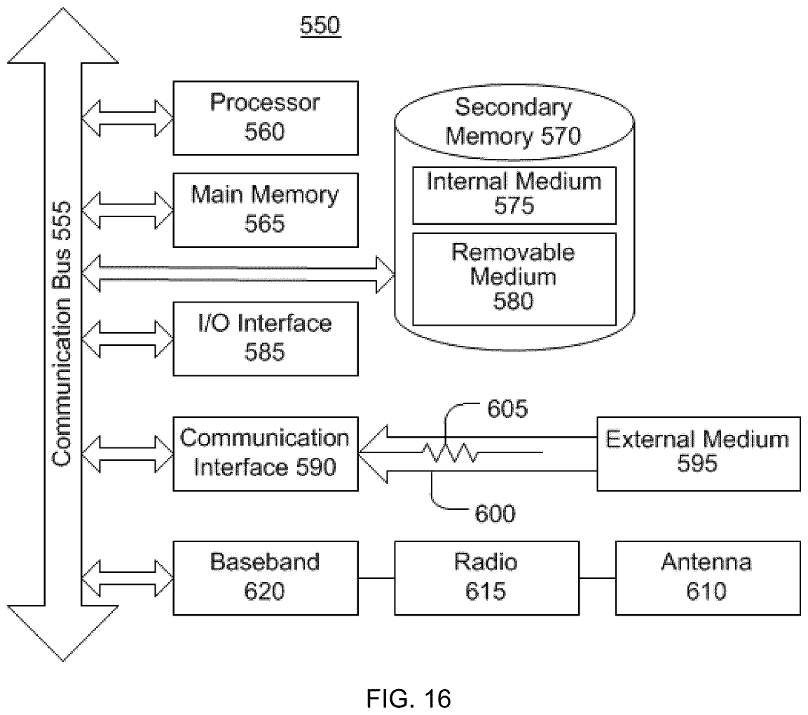

FIG. 16 is a block diagram illustrating an example wired or wireless system 550 that may be used in connection with various embodiments described herein. For example, the system 550 may be used as or in conjunction with the systems and methods for managing stormwater compliance plans as previously described with respect to FIGS. 1-6. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method of managing a stormwater compliance plan (SCP), comprising the steps of:
receiving an SCP for an inspection site, the SCP including site-specific stormwater compliance requirements;
receiving weather information in relation to the inspection site;
comparing the weather information with the site-specific stormwater compliance requirements and creating a Qualifying Rain Event (QRE) if a threshold precipitation level is met;
generating one or more action items in relation to the created QRE; and
receiving compliance activity information from the inspection site.

2. The method of claim 1, further comprising assigning the one or more action items to at least one inspector.

3. The method of claim 2, further comprising transmitting the one or more action items to the at least one inspector.

4. The method of claim 3, further comprising transmitting the one or more action items to the at least one inspector based on a location of the inspector relative to the inspection site.

5. The method of claim 1, wherein the weather information includes at least one of a past amount of precipitation, current amount of precipitation or future chance of precipitation at the site.

6. The method of claim 1, wherein the action items are generated in real-time.

7. The method of claim 1, wherein the one or more action items relate to mitigation of stormwater runoff at the inspection site.

8. The method of claim 1, wherein the action items pertain to at least one notification, alert or task.

9. The method of claim 1, wherein the compliance activity information relates to actions taken at the inspection site to comply with the SCP.

10. The method of claim 1, further comprising generating compliance information for the inspection site based on the received compliance activity information.

11. The method of claim 1, further comprising managing the compliance activity information from the inspector device to ensure compliance with the SCP.

12. A system for managing a stormwater compliance plan (SCP), comprising:
a compliance server configured to:
receive an SCP for an inspection site, the SCP including site-specific stormwater compliance requirements;
receive weather information in relation to the inspection site from a weather information server;
compare the weather information with the site-specific stormwater compliance requirements and creating a Qualifying Rain Event (QRE) if a threshold precipitation level is met; and
generate one or more action items in relation to the created QRE; and
an inspector device configured to:
receive at least one action item from the compliance server;
receive input from an inspector at the inspection site relating to compliance activity information; and
transmit the compliance activity information to the compliance server.

13. The system of claim 10, further comprising a management device which manages the activity information from the inspector device to ensure compliance with the SCP.

14. The system of claim 10, wherein the inspector device further comprises location-based capabilities for transmitting a location of the device to the compliance server.

15. The system of claim 10, wherein the weather information server provides the compliance server with at least one of a past amount of precipitation, current amount of precipitation or future chance of precipitation at the inspection site.

16. The system of claim 13, wherein the weather information is compared with the site-specific stormwater compliance requirements in real-time to create the QRE and generate the one or more action items in relation to the created QRE.

17. The system of claim 10, wherein the compliance server is further configured to generate compliance information for the inspection site based on the received compliance activity information.
